(19) United States
(12) Patent Application Publication
(10) Pub. No.: US 2026/0177361 A1
(43) Pub. Date: Jun. 25, 2026

(54) CLAY TARGET RANGE MONITORING SYSTEM

(71) Applicant: CG Range Link LLC, Lakeland, FL (US)

(72) Inventors: Joseph C. Beall, Lakeland, FL (US); Gaje M. Papponetti, Lakeland, FL (US)

(73) Assignee: CG Range Link LLC, Lakeland, FL (US)

(21) Appl. No.: 19/432,695

(22) Filed: Dec. 24, 2025

Related U.S. Application Data
(60) Provisional application No. 63/738,686, filed on Dec. 24, 2024.

(51) Int. Cl. F41J 9/18; G06Q 30/0283

(52) U.S. Cl. CPC F41J 9/18; G06Q 30/0283

(57) ABSTRACT

A clay target range monitoring system configured to monitor various aspects of one or more clays throwers and related devices and systems is disclosed. The clay target range monitoring system may be configured to monitor operation of one or more clay throwers, such as on a sporting clays course, five stand course, skeet field, trap field and the like. The clay target range monitoring system may be configured to deliver real-time, or near real-time, data to managers and related staff to address issues before they become problems negatively affecting the experience of the shooters, which may result in lost revenue. The clay target range monitoring system may be configured to predict events, such as but not limited to, when a clay thrower will run out of clay targets, when preventive maintenance is needed, when a battery requires maintenance, predictions based on user data and the like.

### CROSS-REFERENCE TO RELATED APPLICATION

This application claims the benefit of U.S. Provisional Patent Application No. 63/738,686, filed on Dec. 24, 2024, all of which are incorporated herein in their entireties.

### BACKGROUND

The disclosure relates to firearm shooting sports, and more particularly, to electronic control systems for monitoring operations of firearm shooting sports.

### SUMMARY OF THE INVENTION

A clay target range monitoring system configured to monitor various aspects of one or more clays throwers and related devices and systems is disclosed. The clay target range monitoring system may be configured to monitor operation of one or more clay throwers, such as on a sporting clays course, five stand course, skeet field, trap field and the like. The clay target range monitoring system may be configured to deliver real-time, or near real-time, data to managers and related staff to address issues before they become problems negatively affecting the experience of the shooters, which may result in lost revenue. The clay target range monitoring system may be configured to predict events, such as but not limited to, when a clay thrower will run out of clay targets, when preventive maintenance is needed, when a battery requires maintenance, predictions based on user data and the like.

In at least one embodiment, the clay target range monitoring system may include a plurality of sensor nodes. One or more of the sensor nodes may include a power supply and a communication device. In at least one embodiment, the plurality of sensor nodes may include one or more sensor nodes positioned in communication with a clay thrower for monitoring operation of the clay thrower. The clay target range monitoring system may include one or more data gateways communicatively coupled to the plurality of sensor nodes via one or more wireless transmission pathways. The data gateway may be configured to receive data collected by the one or more sensors and transmit the data, via a communications system, to at least one remotely positioned server for further processing and storage. The clay target range monitoring system may include one or more remotely positioned servers configured to receive sensor data from at least one sensor node of the plurality of sensor nodes and decode and store incoming sensor data. The one or more servers may also be configured to conduct data evaluation for alarm conditions based on user criteria and manage end user messaging for notifications via email, SMS, voice, or push notifications. The one or more servers may be configured to evaluate data to compile sensor information for specific date and time events and forecast sensor data based on historical patterns, weather, day of the week, and other metrics. The one or more servers may also be configured to recover sensor data in the event of transmission failure and generate custom reports for users based on stored and artificial intelligence generated data and information.

The clay target range monitoring system may include a communications system for transmitting data regarding operations of one or more clay throwers to at least one device positioned remotely from the server. The at least one device positioned remotely from the server may be a mobile or general computing device. The communications system may communicate via WiFi, LoRaWAN, cellular or satellite.

The clay target range monitoring system may include an alarm module for generating alarm notifications when out-of-specification conditions are detected. The clay target range monitoring system may also include an event module configured to generate event costs, revenue, and calculate event profit.

The clay target range monitoring system may include a prediction module configured to generate system predictions based on the received sensor data. The prediction module may be configured to predict maintenance requirements for each clay target thrower to which the clay target range monitoring system is coupled. The prediction module may be configured to track event financials and create predictions based on event data.

The alarm module may be configured to adjust at least one threshold in the alarm module based upon results generated by the prediction module. The clay target range monitoring system may be configured to receive input from a user via one or more mobile devices. The clay target range monitoring system may be configured to send data to at least one user, wherein the data includes user usage patterns and clay thrower maintenance and failure correlations.

The clay target range monitoring system may include at least one remotely positioned server configured with a memory that stores instructions and a processor that executes the instructions to perform operations. The operations may include receiving sensor data from at least one sensor node of the plurality of sensor nodes and decoding the incoming sensor data. The operations may also include storing incoming sensor data and evaluating data to determine whether alarm conditions exist based on user criteria. The operations may include generating end user messaging for notifications via email, short message service messages, voice messages, or push notifications and evaluating sensor data to compile sensor information for specific date and time events. The operations may also include forecasting sensor data based on historical patterns, weather and day of the week and generating reports based on the sensor data from at least one sensor node to facilitate operation of the clay target range monitoring system.

The processor may perform operations based on instructions for generating alarm notifications when an alarm module detects out-of-specification conditions. The processor may further perform operations based on instructions for generating, via an event module, costs, revenue, and clay target shoot event profit. The processor may also perform operations based on instructions for generating, via a prediction module, system predictions based on the received sensor data. The processor may further perform operations based on instructions for predicting, via a prediction module, maintenance requirements for at least one clay target thrower to which the clay target range monitoring system is coupled. The processor may also perform operations based on instructions for tracking event financials and creating predictions, via the prediction module, based on event data. The processor may also perform operations based on instructions for adjusting, via an alarm module, at least one threshold in the alarm module based upon results generated by a prediction module.

An advantage of the system is that the system is configured to alert users, such as management of clay shooting facilities, of clay target thrower failures in a real-time, or near real-time, manner to enable a fast response to reduce downtime and reduce the likelihood of slowdowns of shooter rotation through stations.

Another advantage of the system is that the system is configured to predict maintenance requirements for each clay target thrower at a facility.

Still another advantage of the system is that the system is configured to track event financials and make predictions based on the event data.

Another advantage of the system is that the system is configured to communicate directly with a user's mobile or alternate computer device, such as, but not limited to, a smartphone, tablet, or laptop.

Yet another advantage of the system is that the system is configured to allow the user to access historical clay target thrower data for purposes, such as, but not limited to, clay thrower maintenance and failure correlations and user usage patterns.

These and other embodiments are described in more detail below.

### BRIEF DESCRIPTION OF THE FIGURES

FIG. 1 is a schematic diagram of the clay target range monitoring system.

FIG. 2 is a detailed schematic diagram of the clay target range monitoring system of FIG. 1.

FIG. 3 is a schematic diagram of the communication system.

FIG. 4 is a flow diagram of a sensor in communication with a clay target thrower.

FIG. 5 is a flow diagram of a sensor at a clay shooting station having one or more clay target throwers.

FIG. 6 is a flow diagram of data processing of data generated by a sensor.

FIG. 7 is a flow diagram of an alarm module of the clay target range monitoring system.

FIG. 8 is a flow diagram of an event module of the clay target range monitoring system.

FIG. 9 is a flow diagram of a prediction module of the clay target range monitoring system.

FIG. 10 is a flow diagram of an alarm module of the clay target range monitoring system.

FIG. 11 is an exemplary graphical user interface displaying a clay target thrower monitoring screen.

FIG. 12 is an exemplary graphical user interface displaying a clay target shooting event monitoring screen.

FIG. 13 is an exemplary graphical user interface displaying a clay target thrower battery monitoring screen.

FIG. 14 is an exemplary graphical user interface displaying a clay target thrower monitoring screen.

FIG. 15 is a schematic diagram of the clay target range monitoring system including a communications network enabling users to access data collected via the system from remote locations.

FIG. 16 is a schematic diagram of a machine in the form of a computer system within which a set of instructions, when executed, may cause the machine to perform any one or more of the methodologies or operations of the clay target range monitoring system.

### DETAILED DESCRIPTION OF THE FIGURES

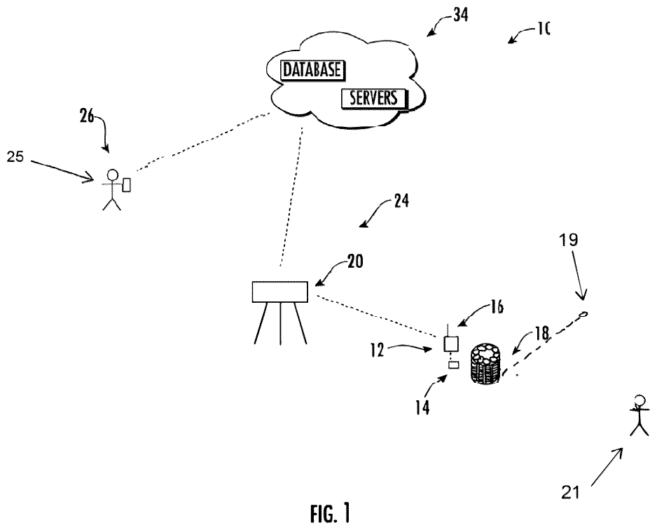

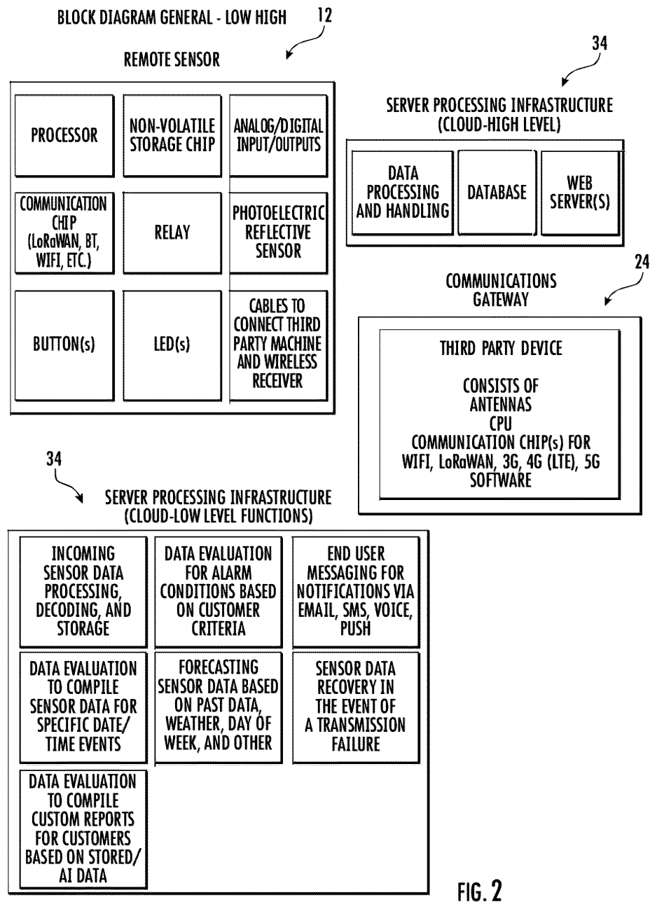

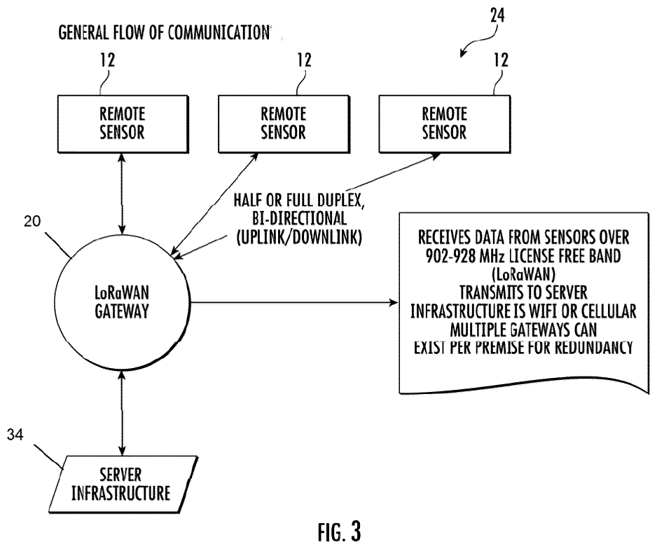

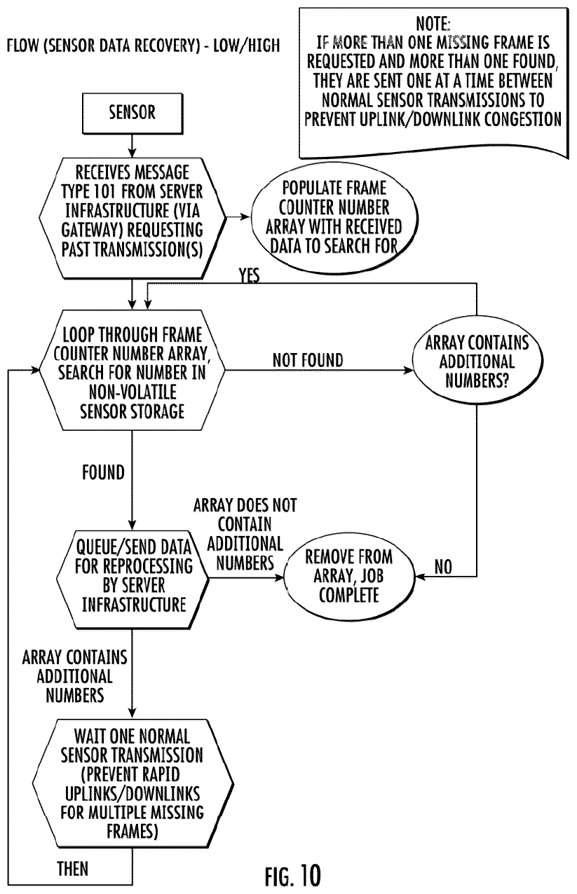

As shown in FIGS. 1-16, a clay target range monitoring system 10 configured to monitor various aspects of one or more clays throwers and related devices and systems is disclosed. The clay target range monitoring system 10 may be configured to monitor operation of one or more clay throwers 18, such as on a sporting clays course, five stand course, skeet field, trap field and the like. These courses may include one or a plurality of clay target throwers 18. One or more shooters 21 may be positioned as desired away from one or more clay target throwers 18 to shoot the clay targets 19 thrown from the clay target throwers 18 such that the clay targets 19 are between 15 and 50 yards away from the shooters 21. The clay target range monitoring system 10 may be configured to deliver real-time, or near real-time, data to managers and related staff to address issues before they become problems negatively affecting the experience of the shooters, which may result in lost revenue. The clay target range monitoring system 10 may be configured to predict events, such as but not limited to, when a clay thrower will run out of clay targets, when preventive maintenance is needed, predictions based on user data and the like.

As shown in FIGS. 1-10, the clay target range monitoring system 10 may include one or more sensor nodes 12. At least one sensor node 12 may include a power supply 14 and a communication device 16. The communication device 16 may include, but is not limited to, a transceiver. The clay target range monitoring system 10 may include a plurality of sensor nodes 12 positioned in communication with a clay target thrower 18 for monitoring operation of the clay thrower 18. The sensor nodes 12 may be any sensor configured to monitor one or more operations of a clay target thrower 18. The sensor nodes 12 may monitor operations, such as, but not limited to, clay target supply amount, number of clay targets on the clay target thrower 18 before it is empty, anticipated time until the clay target thrower 18 is empty if the pace of throwing targets remains the same, whether the clay target thrower 18 threw a broken clay target, number of clay targets thrown, battery voltage, and the like. The power supply 14 may be, but is not limited to being, one or more batteries, solar cells, and municipal power sources. The sensor nodes 12 may be coupled to other components of the clays monitoring system 10 via wire or wireless communication systems. A sensor node 12 may include, but is not limited to including, a processor; non-volatile storage chip; analog/digital inputs and outputs; a communications chip; relay; photoelectric reflective sensor; button(s); LED(s) and cables to connect third party machine and wireless receiver, one or more cameras, infrared cameras, and the like. The sensor node 12 may be configured to be protected from the outside environment and weather typically encountered at clay target ranges.

The clay target range monitoring system 10 may include a data gateway 20, as shown in FIG. 1, communicatively coupled to a plurality of sensor nodes 12 via one or more wireless transmission pathways. The data gateway 20 may be configured to receive the data collected by the one or more sensor nodes 12 and transmit the data to one or more remotely positioned servers 34 for further processing and storage using a communications system 24. For example, the one or more sensor nodes 12 may monitor a battery voltage of a battery coupled to a clay target thrower 18 to determine battery health, battery voltage and other battery metrics. By monitoring battery voltage, the clay target range monitoring system 10 is capable of determining whether a solar panel is charging correctly.

The servers 34, as shown in FIG. 1, may be configured to perform tasks such as decoding and storing incoming sensor data, conducting data evaluation for alarm conditions based on user criteria, managing end user messaging for notifications via communications, such as, but not limited to, notifications via email communication, short message service (SMS) messages, voice communications, push notifications or yet to be developed communications, evaluating data to compile sensor information for specific date and time events, forecasting sensor data based on historical patterns, weather, day of the week, and other metrics, recovering sensor data in the event of transmission failure, and generating custom reports for users based on stored and artificial intelligence generated data.

In particular, the system 10, such as, but not limited to, one or more servers 34, which may be positioned remotely from a clay target range, may be configured for further processing and storage and configured to receive sensor data from one or more sensor nodes 12 of a plurality of sensor nodes 12. The server 34 may be configured to decode and store incoming sensor data from one or more sensor nodes 12. The server 34 may also be configured to conduct data evaluation for alarm conditions based on user criteria. The server 34 may function with an alarm module 28 set forth in detail below. The server 34 may be configured to manage end user messaging for communications, such as, but not limited to, email messages, short message service (SMS) messages, voice messages, voice calls, push notifications, or yet to be developed communications. For instance, the server 34 may manage communications to one or more users 25 via a user's mobile device. As such, a user 25 may remain informed via the user's mobile device via messaging from the system 10, such as from the server 34 or other components of the system 10. The system 10 may be configured to receive input from a user 25 via one or more mobile devices.

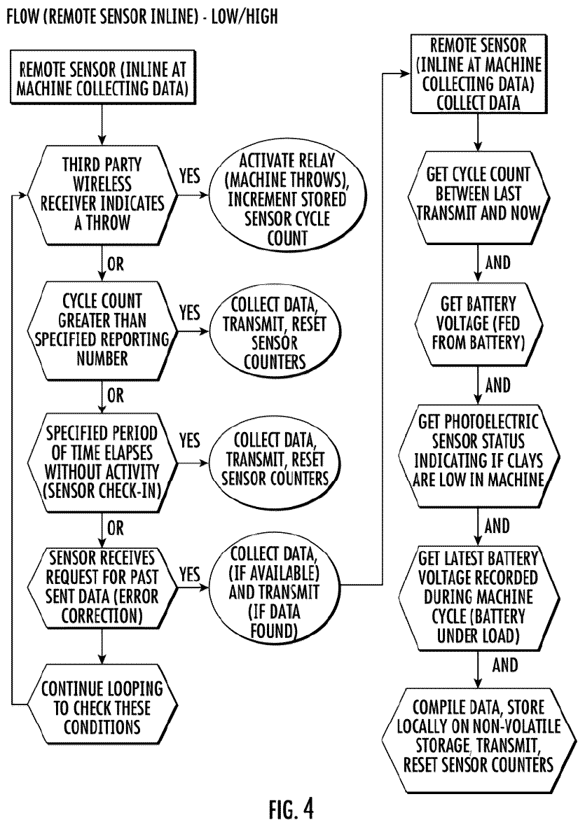

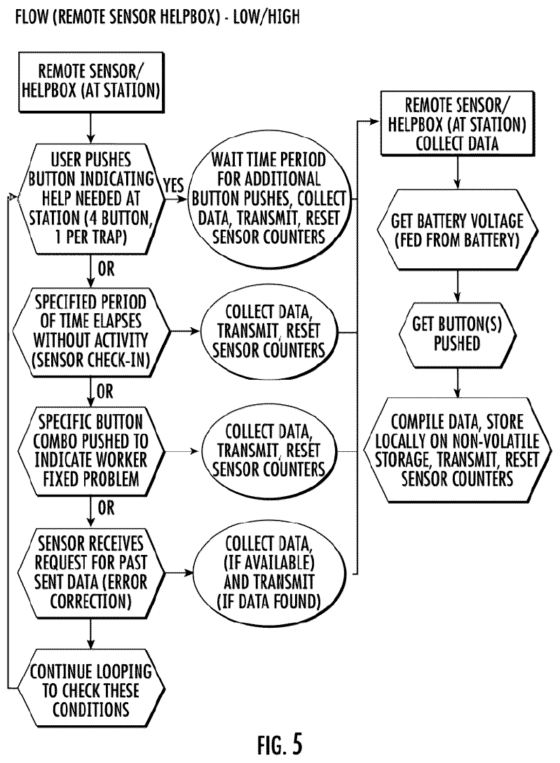

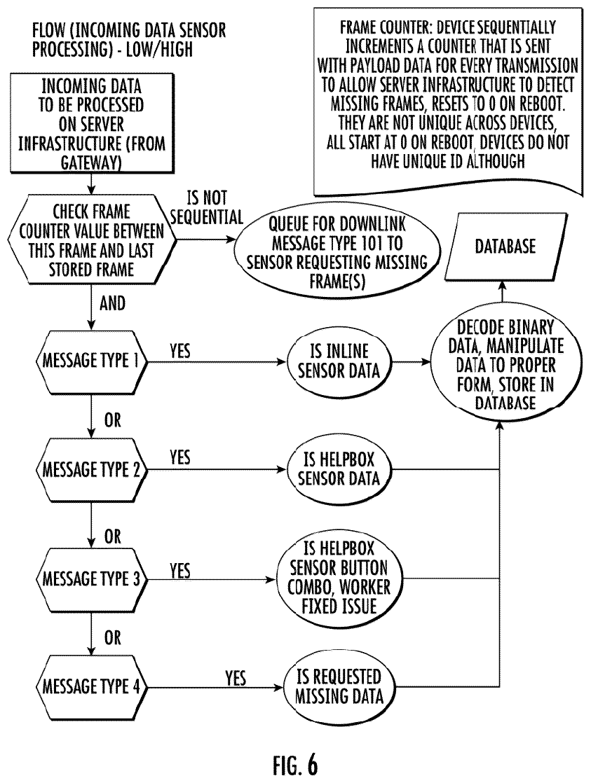

The system 10 may also be configured to evaluate data to compile sensor information for specific date and time events. For example, the system 10 may be configured to process data, via the server 34, from the sensor nodes 12 such as, but not limited to, clay target supply amount, number of clay targets on the clay target thrower 18 before it is empty, anticipated time until the clay target thrower 18 is empty if the pace of throwing targets remains the same, whether the clay target thrower 18 threw a broken clay target, number of clay targets thrown, battery voltage, and other information related to the clay target thrower 18. In at least one embodiment, the system 10 may process data provided by sensor nodes 12 according to the flow charts shown in FIGS. 4-6. In particular, the system 10 may obtain and process data according to the flow diagram of a sensor node 12 in communication with a clay target thrower, as shown in FIG. 4. The system 10 may also obtain and process data according to the flow diagram of a sensor node 12 at a clay shooting station having one or more clay target throwers 18, as shown in FIG. 5. The system 10 may process data generated by one or more sensor nodes 12, as shown in FIG. 6.

The system 10, via the server 34 and the prediction module 32 discussed below, may be configured to forecast sensor data based on historical patterns, weather, day of the week, and other metrics. The system 10, via the server 34, may also be configured to recover sensor data in the event of transmission failure between one or more sensor nodes 12, the data gateway 20 may and the server 34.

The system 10 may be configured to generate reports for users 25, such as users. The system 10 may allow a user 25 to choose from a number of different reports to be generated by the system 10, such as, but not limited to, the server 34. The reports may include data for a particular time frame, such as a one hour period of time, one day, multiple days, one month, multiple months, one year, multiple years, a single event, multiple events and the like. The reports may also include comparable data from the same window of time or event in previous years. The reports may also include forecasts from the prediction module 32 forecasting revenues, expenses of clays, maintenance, trappers, and other expenses associated with a clay target range and related event, such as a competitive or charity clay target shoot. The reports may also include actual and forecasted down time. The system 10 may allow a user 25 to elect for the system to generate a customized report including information and data selected by the user 25. Thus, the system 10 is capable of generating customized reports as specified by a user 25. The system 10 may generate custom reports based on based on stored and artificial intelligence-generated information and data using the prediction module 32. The system 10 may also send data to one or more users 25, whereby the data may include user usage patterns and clay thrower maintenance and failure correlations.

The clay target range monitoring system 10 may include the same communications system 24 for transmitting data regarding the operation of one or more clay target throwers 18 to at least one device 26 positioned remotely from the communication system 24 or server 34, or both. The device 26, which may be a mobile or general computing device such as a smartphone, tablet, laptop, or similar technology, may be configured to display at least a portion of the data associated with the clay target thrower 18. This data is prepared and transmitted by the remotely positioned servers 34. The communications system 24 may use any appropriate communication technology, such as WiFi, LoRaWAN, cellular, satellite, or similar existing or yet-to-be-invented systems.

This logical flow ensures that sensor data is received by the data gateway 20, transmitted via the communications system 24 to the remotely positioned servers 34 for processing, and then made accessible through the same communications system 24 to device 26, ensuring seamless data flow and accessibility to remote users 25. This streamlined approach enhances the efficiency and clarity of the data flow while maintaining the intended functionalities of the system.

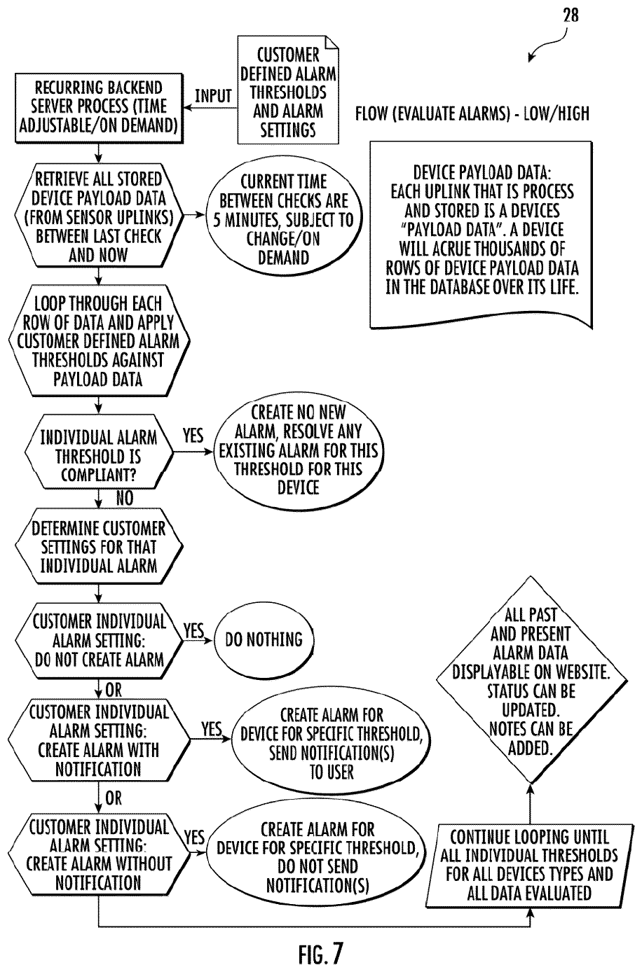

The clay target range monitoring system 10 may include an alarm module 28, as shown in FIG. 7, for generating alarm notifications when the alarm module 28 detects one or more out-of-specification conditions. The out-of-specification condition may include, but are not limited to, a clay target thrower 18 being offline, low supply of clay targets, low battery voltage, low battery voltage during cycle, a maintenance cycle count limit was reached, an accessory sensor is offline, an accessory sensor has indicated an issue requiring attention, or a general anomaly exists within the users data that is determined by artificial intelligence, machine learning, and the like. The alarm module 28 may be configured to adjust one or more thresholds in the alarm module 28 based upon results generated by the prediction module 32.

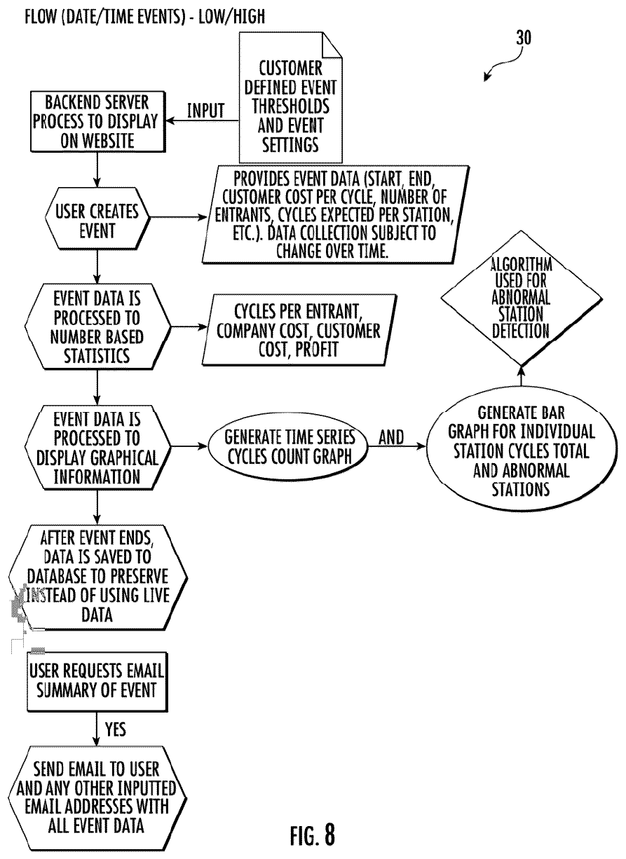

The clay target range monitoring system 10 may include an event module 30, as shown in FIG. 8, configured to calculate event costs, revenue and profit. The event module 30 may also generate other data enabling a user 25, such as management of a sporting clays facility to make educated decisions regarding an event.

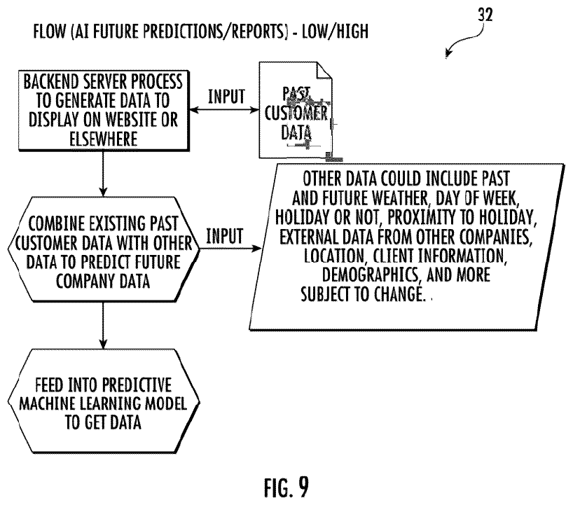

The clay target range monitoring system 10 may include a prediction module 32, as shown in FIG. 9, configured to generate system predictions. In at least one embodiment, the prediction module 32 may generate system predictions based on the received sensor data. The prediction module 32 may use a neural network or machine learning model to generate system predictions. As such, the prediction module 32 may be capable of notifying a user 25 of changes in costs, revenues, weather issues, or any other factor potentially impacting operating of clay target throwers 18 and shooting facilities using clay target throwers 18. The system predictions from the prediction module 32 may also include, but are not limited to, future expected cycle counts on a given day, expected clay thrower failures during a period of time, and peak and off-peak user engagement times to allow for more efficient staffing. The prediction module 32 may also provide a user 25 with predictions of whether a clays shooting event will be profitable, the threshold number of shooters needed to break even and other such metrics in connection with a clays shooting event. The prediction module 32 may be configured to predict maintenance requirements for one or more or each clay target thrower 18 to which the clay target range monitoring system 10 is coupled. The prediction module 32 may be configured to process event financials and other event data and generate predictions based on the event financials and other event data.

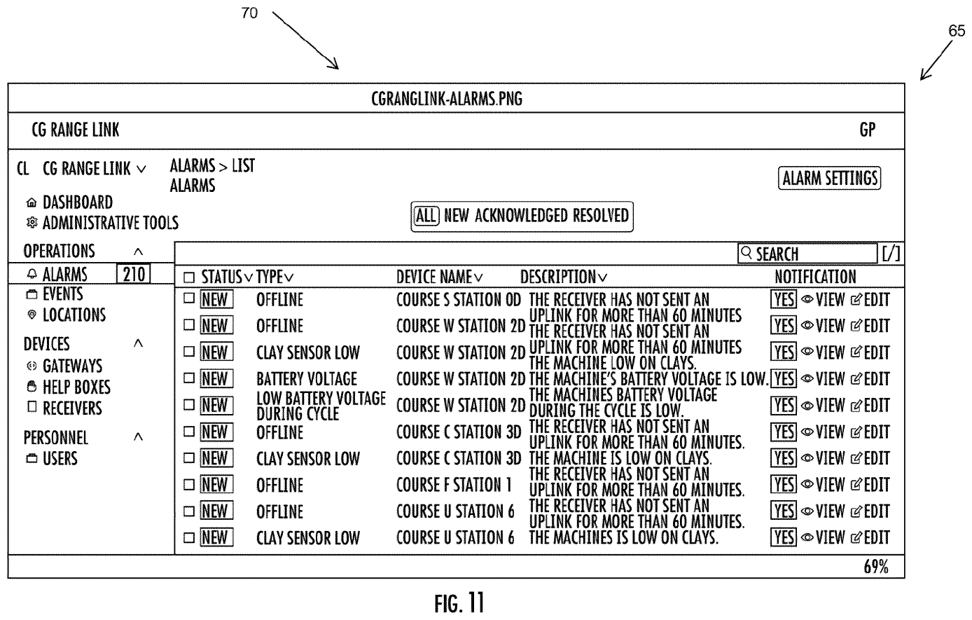

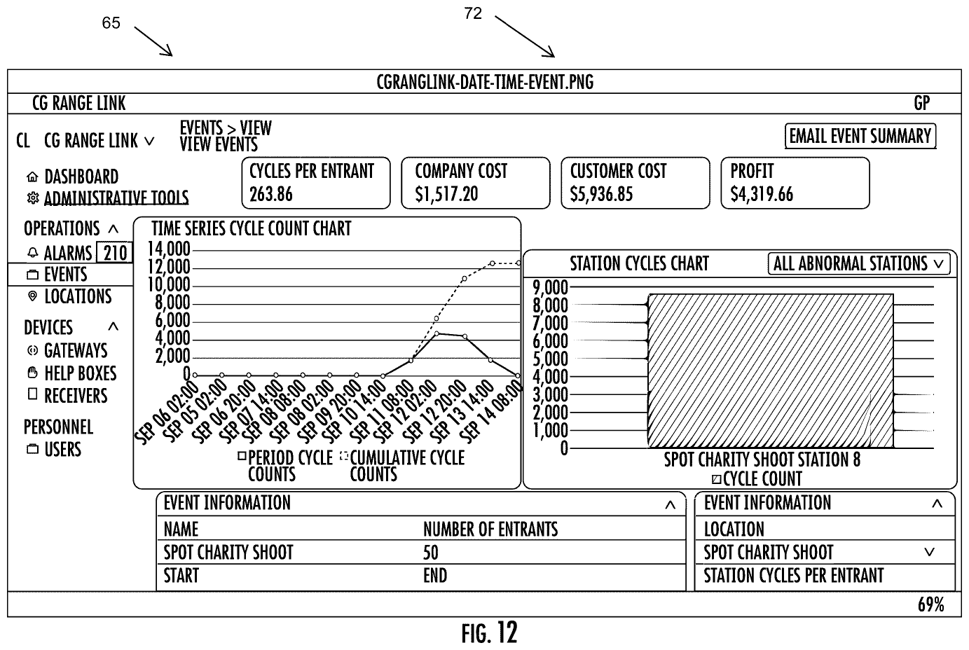

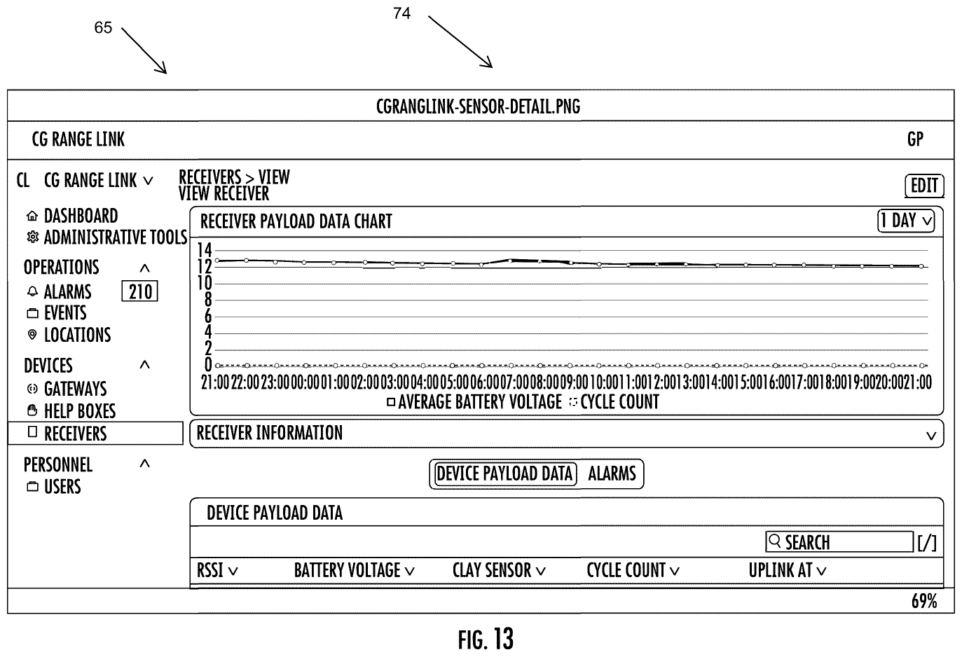

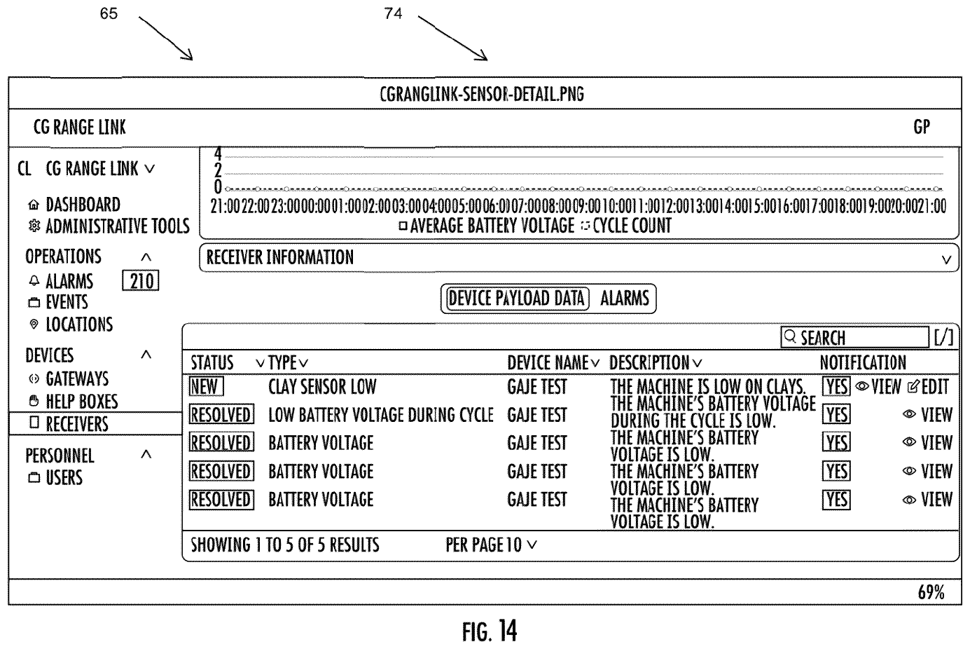

The system 10 may be viewable on one or more graphical user interfaces 65. As shown in FIG. 11, the system 10 may include a clay target thrower monitor 70 displayable on one or more graphical user interfaces 65 enabling a user 25 to analyze metrics of a clay target thrower 18. As shown in FIG. 12, the system 10 may include a clay target shooting event monitor 72 displayable on one or more graphical user interfaces 65 enabling a user to analyze data associated with a clay target shooting event. As shown in FIG. 13, the system 10 may include a clay target thrower battery monitor 74 displayable on one or more graphical user interfaces 65 enabling a user to analyze data related to a clay target thrower 18, such as, but not limited to, battery voltage over time. As shown in FIG. 14, the system 10 may include a clay target thrower battery monitor 74 displayable on one or more graphical user interfaces 65 enabling a user to analyze other data related to a clay target thrower 18.

During use, the clay target range monitoring system 10 enables a user 25, such as, but not limited to, management of a shooting facility, such as a sporting clays facility, to have real-time, or near real-time, monitoring capabilities to determine when clay target throwers 18 are malfunctioning, or may malfunction, at a minimum. Such information enables the course management to address issues immediately to reduce or outright prevent delays, which results in a better experience for shooters and increased revenue to the facility. The clay target range monitoring system 10 may also provide a user 25 with the ability to forecast events using the prediction module 32, such as, but not limited to, maintenance schedules for the clay target throwers 18, time until each machine runs out of clay targets, likelihood of clay target thrower 18 malfunction based on historical data and other systems, the likely number of users on a given day, and the positioning of clay target throwers 18 that will generate the most revenue.

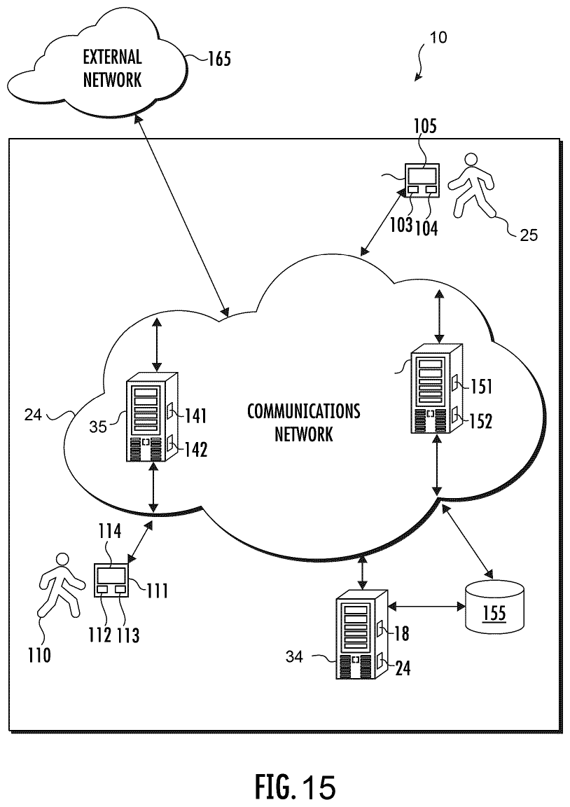

As shown in FIGS. 1 and 15, a clay target range monitoring system 10 configured to monitor various aspects of one or more clays throwers and related devices and systems is disclosed. The diagnostics and review of the data system 10 may take place anywhere desired. The system 10 may be configured to be accessible via system such as, but not limited to, machine learning services, data and content services, computing applications and services, cloud computing services, internet services, satellite services, telephone services, software as a service (SaaS) applications and services, mobile applications and services, platform as a service (PaaS) applications and services, web services, client servers, and any other computing applications and services. The system 10 may include a first user 25, who may utilize a first user device 26 to access data, content, and applications, or to perform a variety of other tasks and functions. As an example, the first user 25 may utilize first user device 26 to access an application (e.g. a browser or a mobile application) executing on the first user device 26 that may be utilized to access web pages, data, and content associated with the system 10. The system 10 may include any number of users.

The first user device 26 utilized by the first user 25 may include a memory 103 that includes instructions, and a processor 104 that executes the instructions from the memory 103 to perform the various operations that are performed by the first user device 26. In certain embodiments, the processor 104 may be hardware, software, or a combination thereof. The first user device 26 may also include an interface 105 (e.g. screen, monitor, graphical user interface, etc.) that may enable the first user 25 to interact with various applications executing on the first user device 26, to interact with various applications executing within the system 10, and to interact with the system 10 itself. In certain embodiments, the first user device 26 may include components that provide non-visual outputs. For example, the first user device 26 may include speakers, haptic components, tactile components, or other components, which may be utilized to generate non-visual outputs that may be perceived and/or experienced by the first user 25. In certain embodiments, the first user device 26 may be configured to not include interface 105. In certain embodiments, the first user device 26 may be a computer, a laptop, a tablet device, a phablet, a server, a mobile device, a smartphone, a smart watch, and/or any other type of computing device. Illustratively, the first user device 26 is shown as a mobile device in FIG. 1. The first user device 26 may also include a global positioning system (GPS), which may include a GPS receiver and any other necessary components for enabling GPS functionality, accelerometers, gyroscopes, sensors, and any other componentry suitable for a mobile device.

In addition to the first user 25, the system 10 may include a second user 110, who may utilize a second user device 111 to access data, content, and applications, or to perform a variety of other tasks and functions. As with the first user 25, in certain embodiments, the second user 110 may be any type of user that may review data from the system 10, total elapsed time of use of an endoscope in a patient 32, or other relevant data. Much like the first user 25, the second user 110 may utilize second user device 111 to access an application (e.g. a browser or a mobile application) executing on the second user device 111 that may be utilized to access web pages, data, and content associated with the system 10. The second user device 111 may include a memory 112 that includes instructions, and a processor 113 that executes the instructions from the memory 112 to perform the various operations that are performed by the second user device 111. In certain embodiments, the processor 113 may be hardware, software, or a combination thereof. The second user device 111 may also include an interface 114 (e.g. a screen, a monitor, a graphical user interface, etc.) that may enable the second user 110 to interact with various applications executing on the second user device 111, to interact with various applications executing in the system 10, and to interact with the system 10. In certain embodiments, the second user device 111 may be a computer, a laptop, a tablet device, a phablet, a server, a mobile device, a smartphone, a smart watch, and/or any other type of computing device. Illustratively, the second user device 111 may be a computing device in FIG. 1. The second user device 111 may also include any of the componentry described for first user device 26.

In certain embodiments, the first user device 26 and the second user device 111 may have any number of software applications and/or application services stored and/or accessible thereon. For example, the first and second user devices 26, 111 may include artificial intelligence-based applications, machine learning-based applications, applications for facilitating the completion of tasks, cloud-based applications, search engine applications, natural language processing applications, database applications, algorithmic applications, phone-based applications, product-ordering applications, business applications, e-commerce applications, media streaming applications, content-based applications, database applications, gaming applications, internet-based applications, browser applications, mobile applications, service-based applications, productivity applications, video applications, music applications, social media applications, presentation applications, any other type of applications, any types of application services, or a combination thereof. In certain embodiments, the software applications and services may include one or more graphical user interfaces so as to enable the first and second users 25, 110 to readily interact with the software applications. The software applications and services may also be utilized by the first and second users 25, 110 to interact with any device in the system 10, any network in the system 10, or any combination thereof. For example, the software applications executing on the first and second user devices 26, 111 may be applications for receiving data, applications for storing data, applications for receiving demographic and preference information, applications for transforming data, applications for executing mathematical algorithms, applications for generating and transmitting electronic messages, applications for generating and transmitting various types of content, any other type of applications, or a combination thereof. In certain embodiments, the first and second user devices 26, 111 may include associated telephone numbers, internet protocol addresses, device identities, or any other identifiers to uniquely identify the first and second user devices 26, 111 and/or the first and second users 25, 110. In certain embodiments, location information corresponding to the first and second user devices 26, 111 may be obtained based on the internet protocol addresses, by receiving a signal from the first and second user devices 26, 111, or based on profile information corresponding to the first and second user devices 26, 111. In certain embodiments, the location information may be obtained by utilizing global positioning systems of the first and/or second user devices 26, 111.

The system 10 may also include a communications network 24. The communications network 24 of the system 10 may be configured to link each of the devices in the system 10 to one another. For example, the communications network 24 may be utilized by the first user device 26 to connect with other devices within or outside communications network 24. Additionally, the communications network 24 may be configured to transmit, generate, and receive any information and data traversing the system 10. In certain embodiments, the communications network 24 may include any number of servers, databases, or other componentry, and may be controlled by a service provider. The communications network 24 may also include and be connected to a cloud-computing network, a phone network, a wireless network, an Ethernet network, a satellite network, a broadband network, a cellular network, a private network, a cable network, the Internet, an internet protocol network, a content distribution network, a virtual private network, any network, or any combination thereof. Illustratively, server 35 and server 36 are shown as being included within communications network 24. Notably, the functionality of the system 10 may be supported and executed by using any combination of the servers 35, 36, and 34. The servers 35, and 36 may reside in communications network 24, however, in certain embodiments, the servers 35, 36 may reside outside communications network 24. The servers 35 and 36 may be utilized to perform the various operations and functions provided by the system 10, such as those requested by applications executing on the first and second user devices 26, 111. In certain embodiments, the server 35 may include a memory 141 that includes instructions, and a processor 142 that executes the instructions from the memory 141 to perform various operations that are performed by the server 35. The processor 142 may be hardware, software, or a combination thereof. Similarly, the server 36 may include a memory 151 that includes instructions, and a processor 152 that executes the instructions from the memory 151 to perform the various operations that are performed by the server 36. In certain embodiments, the servers 35, 36, and 34 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 35, 36 may be communicatively linked to the communications network 24, any network, any device in the system 10, or any combination thereof.

The database 155 of the system 10 may be utilized to store and relay information that traverses the system 10, cache information and/or content that traverses the system 10, store data about each of the devices in the system 10, and perform any other typical functions of a database. In certain embodiments, the database 155 may store the output from any operation performed by the system 10, operations performed and output generated by the first and second user devices 26, 111, the servers 35, 36, 34, or any combination thereof. In certain embodiments, the database 155 may store a record of any and all information obtained from any data sources utilized by the system 10 to facilitate the operative functions of the system 10 and its components, store any information and data obtained from the internal and external data sources 201, 202, store the agglomerated models 208, store outputs generated by an application under evaluation 230, store feedback received from the first and second users 25, 110 and/or the first and second user devices 26, 111, store inputs entered into or utilized to interact with the application under evaluation 230, store software code 245 generated by the system 10, store reports 242 generated by the system 10, store analyses 243 generated by the system 10, store test results 246 generated by the system 10, store test data 247, store media training videos and media content, store any information generated and/or received by the system 10, any other data traversing the system 10, or any combination thereof. In certain embodiments, the database 155 may be connected to or reside within the communications network 24, any other network, or a combination thereof. In certain embodiments, the database 155 may serve as a central repository for any information associated with any of the devices and information associated with the system 10. Furthermore, the database 155 may include a processor and memory or be connected to a processor and memory to perform the various operations associated with the database 155. In certain embodiments, the database 155 may be connected to the servers 35, 36, 34, the first user device 26, the second user device 111, any devices in the system 10, any other device, any network, or any combination thereof.

The database 155 may also store information obtained from the system 10, store information associated with the first and second users 25, 110, store location information for the first and second user devices 26, 111 and/or first and second users 25, 110, store user profiles associated with the first and second users 25, 110, store device profiles associated with any device in the system 10, store communications traversing the system 10, store user preferences, store demographic information for the first and second users 25, 110, store information associated with any device or signal in the system 10, store information relating to usage of applications accessed by the first and second user devices 26, 111, store any information obtained from any of the networks in the system 10, store historical data associated with the first and second users 25, 110, store device characteristics, store information relating to any devices associated with the first and second users 25, 110, or any combination thereof. The user profiles may include any type of information associated with an individual (e.g. first user 25 and/or second user 110), such as, but not limited to a username, a password, contact information, demographic information, psychographic information, an identification of applications used or associated with the individual, any attributes of the individual, any other information, or a combination thereof. Device profiles may include any type of information associated with a device, such as, but not limited to, operating system information, hardware specifications, information about each component of the device (e.g. sensors, processors, memories, batteries, etc.), attributes of the device, any other information, or a combination thereof.

In certain embodiments, the database 155 may store algorithms facilitating the operation of the system 10 itself, any software application utilized by the system 10, or any combination thereof. In certain embodiments, the database 155 may be configured to store any information generated and/or processed by the system 10, store any of the information disclosed for any of the operations and functions disclosed for the system 10 herewith, store any information traversing the system 10, or any combination thereof. Furthermore, the database 155 may be configured to process queries sent to it by any device in the system 10.

In certain embodiments, the system 10 may communicate and/or interact with an external network 165. In certain embodiments, the external network 165 may include any number of servers, databases, or other componentry, and, in certain embodiments, may be controlled by a service provider. The external network 165 may also include and be connected to a cloud-computing network, a phone network, a wireless network, an Ethernet network, a satellite network, a broadband network, a cellular network, a private network, a cable network, the Internet, an internet protocol network, a content distribution network, a virtual private network, any network, or any combination thereof.

The system 10 may also include a software application or program, which may be configured to perform and support the operative functions of the system 10. In certain embodiments, the application may be a software program, a website, a mobile application, a software application, a software process, or a combination thereof, which may be made accessible to users utilizing one or more computing devices, such as first user device 26 and second user device 111. The application of the system 10 may be accessible via an internet connection established with a browser program executing on the first or second user devices 26, 111, a mobile application executing on the first or second user devices 26, 111, or through other suitable means. Additionally, the application may allow users and computing devices to create accounts with the application and sign-in to the created accounts with authenticating username and password log-in combinations. In certain embodiments, the software application may execute directly as an installed program on the first and/or second user devices 26, 111, such as a mobile application or a desktop application. In certain embodiments, the software application may execute directly on any combination of the servers 35, 36, 34.

The software application may include multiple programs and/or functions that execute within the software application and/or are accessible by the software application. For example, the software application may include an application that generates web content and pages that may be accessible to the first and/or second user devices 26, 111, any type of program, or any combination thereof.

The systems and methods disclosed herein may include further functionality and features. For example, the operative functions of the system 10 and methods 30 may be configured to execute on a special-purpose processor specifically configured to carry out the operations provided by the system 10 and methods 30. Notably, the operative features and functionality provided by the system 10 and methods 30 may increase the efficiency of computing devices that are being utilized to facilitate the functionality provided by the system 10 and methods 30. For example, the system 10 and methods 30 can optimize the performance of future actions through machine learning, such that a reduced amount of computer operations need to be performed by the devices in the system 10 using the processors and memories of the system 10 than in systems that are not capable of machine learning as described in this disclosure. In such a context, less processing power may need to be utilized because the processors and memories do not need to perform actions, operations, and analyses that have already been conducted by the system 10. In certain embodiments, the system 10 may learn that certain state(s) associated with and/or from discovery and/or testing may be faster on certain processing hardware. For example, for a state with complex mathematical operations and/or graphics, the system 10 may perform better when there is a floating point processor or a graphics processing unit. As a result, the functionality provided by the system 10 and methods 30 may provide substantial savings in the usage of computer resources by utilizing the software and functionality provided in the present disclosure.

Notably, in certain embodiments, various functions and features of the system 10 and methods may operate without human intervention and may be conducted entirely by computing devices, robots, programs, and/or processes. For example, in certain embodiments, multiple computing devices may interact with devices of the system 10 to provide the functionality supported by the system 10. Additionally, in certain embodiments, system 10 may operate continuously to reduce the possibility of defects, conflicts, and/or errors from being introduced into the system 10. In certain embodiments, the system 10 and method may also provide effective computing resource management by utilizing the features and functions described in the present disclosure. For example, in certain embodiments, the system 10 may specify a quantity of computer processor resources (e.g. processor clock cycles, processor speed, processor cache, etc.) that may be dedicated to obtaining data from the camera 20. For example, the system 10 may indicate a quantity of processor cycles of a processor that may be utilized to obtain data, process obtained data, and/or specify a selected amount of processing power that may be dedicated to obtaining and processing data from the camera 20.

In certain embodiments, any device or program in the system 10 may transmit a signal to a memory device to cause the memory device to only dedicate a selected amount of memory resources to the various operations of the system 10. In certain embodiments, the system 10 and methods may also include transmitting signals to processors and memories to only perform the operative functions of the system 10 and methods 30 at time periods when usage of processing resources and/or memory resources in the system 10 is at a selected and/or threshold value. In certain embodiments, the system 10 and methods may include transmitting signals to the memory devices utilized in the system 10, which indicate which specific portions (e.g. memory sectors, etc.) of the memory should be utilized to store any of the data utilized or generated by the system 10. Notably, the signals transmitted to the processors and memories may be utilized to optimize the usage of computing resources while executing the operations conducted by the system 10. As a result, such features provide substantial operational efficiencies and improvements over existing technologies.

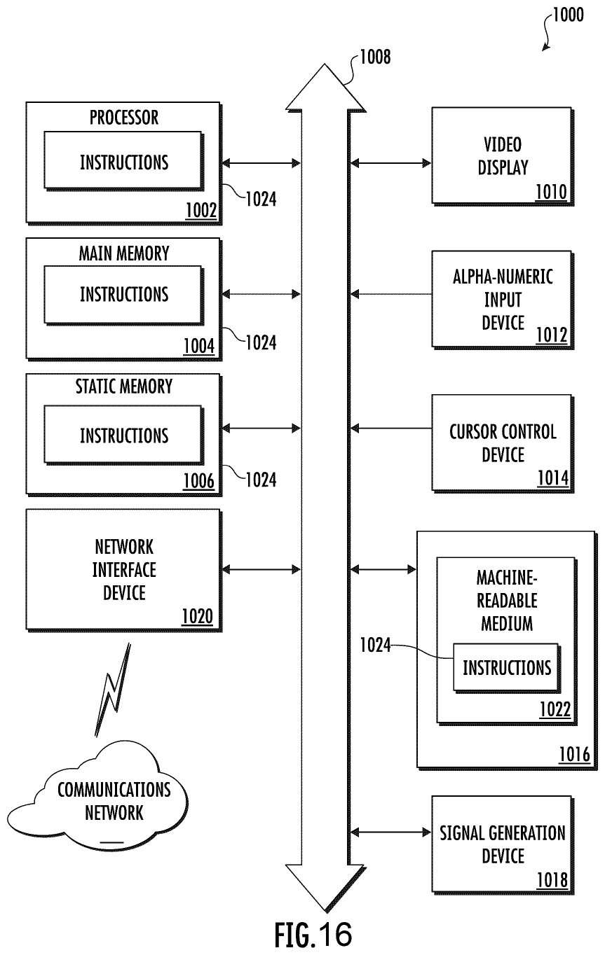

Referring now also to FIG. 16, at least a portion of the methodologies and techniques described with respect to the exemplary embodiments of the system 10 can incorporate a machine, such as, but not limited to, computer system 1000, or other computing device within which a set of instructions, when executed, may cause the machine to perform any one or more of the methodologies or functions discussed above. The machine may be configured to facilitate various operations conducted by the system 10. For example, the machine may be configured to, but is not limited to, assist the system 10 by providing processing power to assist with processing loads experienced in the system 10, by providing storage capacity for storing instructions or data traversing the system 10, or by assisting with any other operations conducted by or within the system 10.

In some embodiments, the machine may operate as a standalone device. In some embodiments, the machine may be connected (e.g., using communications network 24, another network, or a combination thereof) to and assist with operations performed by other machines and systems, such as, but not limited to, the first user device 26, the second user device 111, the server 35, the server 36, the database 155, the server 34, or any combination thereof. The machine may assist with operations performed by other component in the system, any programs in the system, or any combination thereof. The machine may be connected with any component in the system 10. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

Referring now also to FIG. 11, at least a portion of the methodologies and techniques described with respect to the exemplary embodiments of the system 10 can incorporate a machine, such as, but not limited to, computer system 1000, or other computing device within which a set of instructions, when executed, may cause the machine to perform any one or more of the methodologies or functions discussed above. The machine may be configured to facilitate various operations conducted by the system 10. For example, the machine may be configured to, but is not limited to, assist the system 10 by providing processing power to assist with processing loads experienced in the system 10, by providing storage capacity for storing instructions or data traversing the system 10, or by assisting with any other operations conducted by or within the system 10.

In some embodiments, the machine may operate as a standalone device. In some embodiments, the machine may be connected (e.g., using communications network 24, another network, or a combination thereof) to and assist with operations performed by other machines and systems, such as, but not limited to, a first user device 26, a second user device 111, the server 35, the server 36, the database 155, the server 34, or any combination thereof. The machine may assist with operations performed by other component in the system, any programs in the system, or any combination thereof. The machine may be connected with any component in the system 10. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 1000 may include a processor 1002 (e.g., a central processing unit (CPU), a graphics processing unit (GPU, or both), a main memory 1004 and a static memory 1006, which communicate with each other via a bus 1008. The computer system 100 may further include a video display unit 250, which may be, but is not limited to, a liquid crystal display (LCD), a flat panel, a solid state display, or a cathode ray tube (CRT). The computer system 1000 may include an input device 252, such as, but not limited to, a keyboard, a cursor control device 254, such as, but not limited to, a mouse, a disk drive unit 256, a signal generation device 258, such as, but not limited to, a speaker or remote control, and a network interface device 260.

The disk drive unit 256 may include a machine-readable medium 262 on which is stored one or more sets of instructions 264, such as, but not limited to, software embodying any one or more of the methodologies or functions described herein, including those methods illustrated above. The instructions 264 may also reside, completely or at least partially, within the main memory 1004, the static memory 1006, or within the processor 62, or a combination thereof, during execution thereof by the computer system 100. The main memory 1004 and the processor 62 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations may include, but are not limited to, distributed processing or component/object distributed processing, parallel processing, or virtual machine processing can also be constructed to implement the methods described herein.

The present disclosure contemplates a machine-readable medium 262 containing instructions 264 so that a device connected to the communications network 24, another network, or a combination thereof, can send or receive voice, video or data, and communicate over the communications network 24, another network, or a combination thereof, using the instructions. The instructions 264 may further be transmitted or received over the communications network 24, another network, or a combination thereof, via the network interface device 260.

While the machine-readable medium 262 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. A clay target range monitoring system, comprising:
a plurality of sensor nodes, at least one sensor node comprising:
a power supply; and
a communication device;
wherein the plurality of sensor nodes includes one or more sensor nodes positioned in communication with a clay thrower for monitoring operation of the clay thrower;
a data gateway communicatively coupled to the plurality of sensor nodes via one or more wireless transmission pathways, wherein the data gateway is configured to:
receive the data collected by the one or more sensors; and
transmit the data, via a communications system, to at least one remotely positioned server for further processing and storage;
at least one remotely positioned server configured to:
receive sensor data from at least one sensor node of the plurality of sensor nodes;
decode and store incoming sensor data;
conduct data evaluation for alarm conditions based on user criteria;
manage end user messaging for notifications via email, SMS, voice, or push notifications;
evaluate data to compile sensor information for specific date and time events;
forecast sensor data based on historical patterns, weather, day of the week, and other metrics;
recover sensor data in the event of transmission failure; and
generate custom reports for users based on stored data.

2. The clay target range monitoring system of claim 1, further comprising a communications system for transmitting data regarding operations of at least one clay thrower to at least one device positioned remotely from the server.

3. The clay target range monitoring system of claim 2, wherein at least one device positioned remotely from the server is a mobile or general computing device.

4. The clay target range monitoring system of claim 2, wherein the communications system communicates via WiFi, LoRaWAN, cellular or satellite.

5. The clay target range monitoring system of claim 2, further comprising an alarm module for generating alarm notifications when out-of-specification conditions are detected.

6. The clay target range monitoring system of claim 2, further comprising an event module configured to generate event costs, revenue, and calculate event profit.

7. The clay target range monitoring system of claim 2, further comprising a prediction module configured to generate system predictions based on the received sensor data.

8. The clay target range monitoring system of claim 7, wherein the prediction module is configured to predict maintenance requirements for each clay target thrower to which the clay target range monitoring system is coupled.

9. The clay target range monitoring system of claim 7, wherein the prediction module is configured to track event financials and create predictions based on event data.

10. The clay target range monitoring system of claim 7, wherein the alarm module is configured to adjust at least one threshold in the alarm module based upon results generated by the prediction module.

11. The clay target range monitoring system of claim 1, wherein the system is configured to receive input from a user via one or more mobile devices.

12. The clay target range monitoring system of claim 1, wherein the system sends data to at least one user and wherein the data includes user usage patterns and clay thrower maintenance and failure correlations.

13. A clay target range monitoring system, comprising:
a plurality of sensor nodes, each sensor node comprising:
a power supply; and
a communication device;
wherein the plurality of sensor nodes includes one or more sensor nodes positioned in communication with a clay thrower for monitoring operation of the clay thrower;
a data gateway communicatively coupled to the plurality of sensor nodes via one or more wireless transmission pathways, wherein the data gateway is configured to:
receive the data collected by the one or more sensors; and
transmit the data, via a communications system, to at least one remotely positioned server for further processing and storage;
at least one remotely positioned server configured to:
a memory that stores instructions;
a processor that executes the instructions to perform operations, the operations comprising:
receiving sensor data from at least one sensor node of the plurality of sensor nodes;
decoding the incoming sensor data;
storing incoming sensor data;
evaluating data to determine whether alarm conditions exist based on user criteria;
generating end user messaging for notifications via email, short message service messages, voice messages, or push notifications;
evaluating sensor data to compile sensor information for specific date and time events;
forecasting sensor data based on historical patterns, weather and day of the week; and
generating reports based on the sensor data from at least one sensor node to facilitate operation of the clay target range monitoring system.

14. The clay target range monitoring system of claim 13, wherein the processor that performs operations based on instructions for generating alarm notifications when an alarm module detects out-of-specification conditions.

15. The clay target range monitoring system of claim 13, wherein the processor that performs operations based on instructions for generating, via an event module, costs, revenue, and clay target shoot event profit.

16. The clay target range monitoring system of claim 13, wherein the processor that performs operations based on instructions for generating, via a prediction module, system predictions based on the received sensor data.

17. The clay target range monitoring system of claim 13, wherein the processor that performs operations based on instructions for predicting, via a prediction module, maintenance requirements for at least one clay target thrower to which the clay target range monitoring system is coupled.

18. The clay target range monitoring system of claim 13, wherein the processor that performs operations based on instructions for tracking event financials and creating predictions, via the prediction module, based on event data.

19. The clay target range monitoring system of claim 13, wherein the processor that performs operations based on instructions for adjusting, via an alarm module, at least one threshold in the alarm module based upon results generated by a prediction module.

20. A clay target range monitoring system, comprising:
a plurality of sensor nodes, each sensor node comprising:
a power supply; and
a communication device;
wherein the plurality of sensor nodes includes one or more sensor nodes positioned in communication with a clay thrower for monitoring operation of the clay thrower;
a data gateway communicatively coupled to the plurality of sensor nodes via one or more wireless transmission pathways, wherein the data gateway is configured to:
receive the data collected by the one or more sensors; and
transmit the data, via a communications system, to at least one remotely positioned server for further processing and storage;
at least one remotely positioned server configured to:
receive sensor data from at least one sensor node of the plurality of sensor nodes;
decode and store incoming sensor data;
conduct data evaluation for alarm conditions based on user criteria;
manage end user messaging for notifications via email, SMS, voice, or push notifications;
evaluate data to compile sensor information for specific date and time events;
forecast sensor data based on historical patterns, weather, day of the week, and other metrics;
recover sensor data in the event of transmission failure; and
generate reports for users based on stored data;
a prediction module configured to generate system predictions based on the received sensor data.
